(19) United States
(12) Patent Application Publication
(10) Pub. No.: US 2007/0001751 A1
(43) Pub. Date: Jan. 4, 2007

(54) System and method for providing an accurate reference bias current

(75) Inventor: Raj Sundararaman, Mission Viejo, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/238,768

(22) Filed: Sep. 29, 2005

Related U.S. Application Data
(60) Provisional application No. 60/696,132, filed on Jul. 1, 2005.

(51) Int. Cl. G05F 1/10

(52) U.S. Cl. 327/541

(57) ABSTRACT

A system and related method are provided for producing a reference bias current that varies within a limited threshold from its nominal value based on band gap voltage, and that generates the bias current substantially independent from process and temperature. In one embodiment, the invention provides a process dependant voltage generator, a temperature independent voltage generator, and a voltage to current converter receiving inputs from bandgap voltage generator and a temperature independent voltage generator to generate a bias current that is substantially independent from process and temperature.

### RELATED APPLICATIONS

This application claims priority based on U.S. Provisional Application No. 60/696,132, filed on Jul. 1, 2005.

### BACKGROUND

Reference currents are needed for various blocks in an integrated circuit for proper biasing of the block. Typically a constant voltage derived from the band gap is impressed across a resistor. The current in the resistor is sensed and mirrored by a current mirror to generate the reference currents for the various blocks. Resistors are typically made of poly-silicon. A current derived in this manner tracks the sheet resistance variation of the poly-silicon which could be as much as ±2% over process corners from the nominal value. Variations of this order, if left untrimmed, cannot guarantee proper functioning of the circuits. One way of trimming this deviation to an acceptable value is by blowing a set of fuses that would add or subtract current as the case may be. However this process involves measuring the reference current and then programming the appropriate fuses to be blown. This is a time consuming process and takes up a lot of test time adding to the final cost of production. Fuses also occupy large areas of silicon in the chip thus rendering it cost ineffective.

In conventional circuits, large, cumbersome fuse circuits are used to trim the variation seen in these reference currents. Furthermore, conventional circuits may use fuse circuits to compensate for either temperature, power supply, or process corner variations, but not all three. Also, the process of trimming by fuse blowing is a time consuming process during testing and packaging.

Therefore, there exists a need in the art for a device and method to address the shortcomings of the prior art, including the variations over all the above mentioned corners. As will be seen, the invention overcomes these shortcomings in an elegant manner.

### BRIEF DESCRIPTION OF THE DRAWINGS

FIG. 1 is a diagrammatic view of a circuit configured according to the invention;

FIG. 2 is a diagrammatic view of a process dependent voltage generator of FIG. 1;

FIG. 3 is a diagrammatic view of a process dependent voltage generator of FIG. 1; and

FIG. 4 is a diagrammatic view of a voltage to current converter of FIG. 1.

### DETAILED DESCRIPTION

The invention is directed to a reference bias current circuit for delivering a reference bias current, where the variation in the current caused by process technology is reduced considerably. This device includes a process dependant voltage generator configured to trim the variance over the process corners. The process dependant voltage generator includes an input configured to receive the band gap voltage and an output that is a process dependant voltage. The device further includes a temperature independent voltage generator configured to compensate for the temperature dependencies of its output current without affecting the process dependencies already established. The temperature independent voltage generator includes an input for receiving the process dependant voltage, and an output configured to produce a temperature independent voltage. A voltage to current converter is configured to produce a reference bias current, and includes two inputs, one being the band gap voltage, and the other being the generated temperature independent voltage. The voltage to current converter produces the compensated reference bias current. The device is configured to receive the band gap voltage as an input, compensate for variances in process, temperature, and power supply, and deliver a reference bias current.

In practice, this reference bias current may vary less than ±8% from its nominal value or better in the environment of process, temperature and power supply corners. The invention enables a novel circuit configuration that produces a reference bias current has been designed based on a band gap voltage. This circuit provides an economical solution in generating a reference current that is essential for biasing various blocks in an integrated circuit (IC). Furthermore, the novel circuit guarantees by design a strict control over the reference current variation by compensating for all operating variables such as temperature, power supply, and process corners.

Generally, an electronic device is provided that delivers a reference bias current that varies within a limited threshold from its nominal value based on band gap voltage. The device includes a process dependant voltage generator, a temperature independent voltage generator, which may be substantially configured with parasitic bipolar transistors, and a voltage to current converter receiving inputs from a bandgap voltage generator and a temperature independent voltage generator and to output a reference bias current based on the band gap voltage of the electronic device.

In one embodiment, an electronic device is provided that delivers a reference bias current that varies within a limited threshold from its nominal value based on band gap voltage. The device includes a process dependant voltage generator and a temperature independent voltage generator. The process dependent voltage generator includes an amplifier for receiving a voltage bias voltage, an output configured to output a current to a transistor gate, and another input for receiving a feedback signal from the transistor. The process dependent voltage generator further includes a current mirror circuit [M2, M3] connected to the transistor to produce a current in the transistor when a signal is received by the transistor from the amplifier. The circuit further includes a resistor connected at one end to the transistor and at another end to ground and an output circuit having a first and second output transistors connected in series [M4, M5] configured to generate a process dependent output signal that varies according to the process corners. The temperature independent voltage generator circuit is substantially configured with parasitic bipolar transistors. The device further includes a voltage to current converter receiving outputs from the bandgap voltage generator and a temperature independent voltage generator and to output a reference bias current based on the band gap voltage of the electronic device

In one embodiment, the invention provides an integrated circuit that provides a reference bias current that does not vary more than ±8% from its nominal value by using several circuit design techniques that compensate for the variations that could arise from a given process technology, wide range of operating temperature and power supplies. A circuit embodying the invention can replace previous solutions for providing precise reference currents to various portions of an IC.

As discussed in the background, in conventional circuits, fuse circuits were used to trim the variation seen in these reference currents, cutting down the variation of the reference voltage. These fuses are large and cumbersome, and take up a large amount of IC area. The process of trimming by fuse blowing is a time consuming process during testing and packaging. A circuit configured according to the invention takes up significantly less area than conventional circuits. Furthermore, the novel circuit saves considerable time testing by guaranteeing a tight control over the reference current variation by design. This circuit can be implemented in future CMOS image sensor devices and in any other IC that needs a tight control over the variation of the reference current.

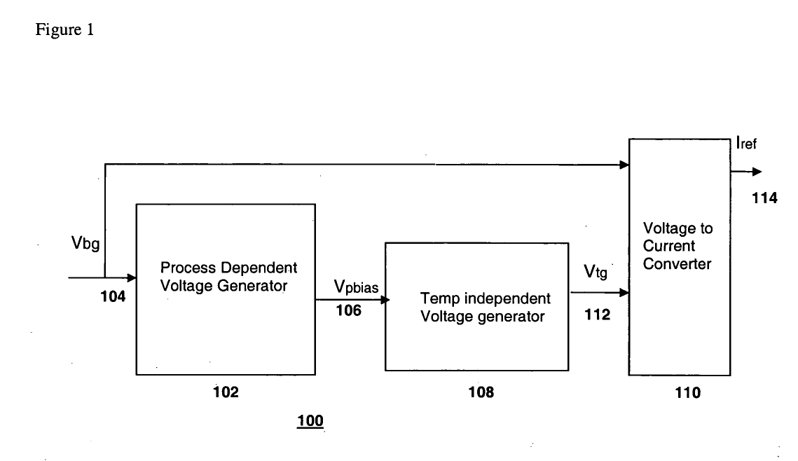

Referring to FIG. 1, a block diagram representation of the reference bias current generator configured according to the invention is illustrated. The circuit consists of a process dependent voltage generator 102 configured to receive an input signal 104, Vbg, and to output a process dependent bias voltage, Vpbias, 106. The circuit further includes a temperature independent voltage generator 108 configured to receive the Vpbias value and to output a temperature independent voltage value, Vtg, 112. The circuit also includes a voltage to current converter 110 configured to receive Vbg and Vtg and to generate a reference current, Iref, 114, that is independent from process and temperature.

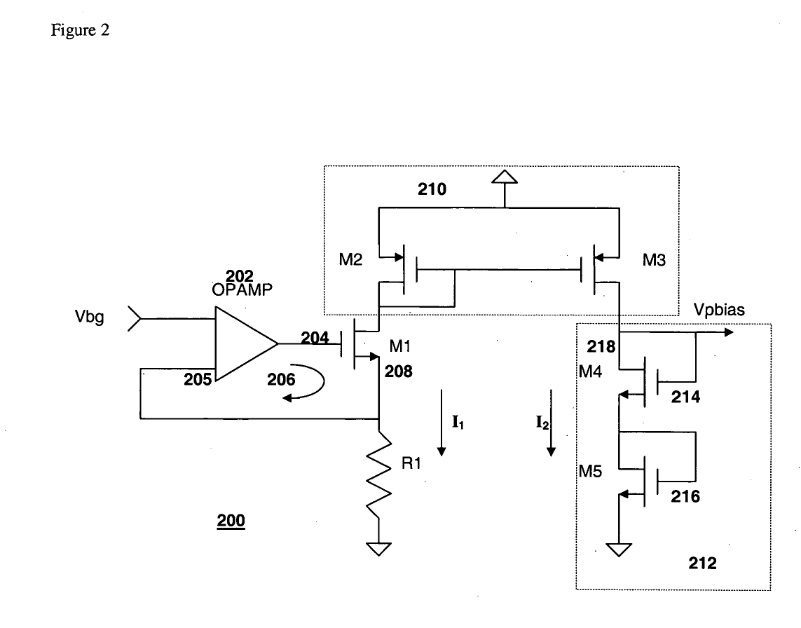

FIG. 2 shows a more detailed diagrammatic view of the process dependant voltage generator. The process dependant voltage generator receives a constant band gap voltage as its input and impresses it on a resistor, R1, thus producing a process dependent current. This current is then mirrored using MOSFETs, M2 and M3 and forced in to MOSFETs M4 and M5. Advantage is taken of the threshold voltage needed to turn on these MOSFETs as they also vary with process corners to generate a process dependent voltage, Vpbias. In particular, in one embodiment as shown, a process independent voltage generator 200 includes an amplifier 202, possibly an operational amplifier as shown, configured to receive a voltage bias voltage. The amplifier includes an output 204 configured to drive gate of transistor M1, and another input 205 for receiving a feedback signal through loop 206 through the transistor output 208. The voltage generator further includes current mirror 210 connected to the transistor M1.A resistor R1 is connected between the source of the transistor M1 and ground. The resistor in conjunction with the bandgap voltage forces a current I1 to flow through M1 which is then mirrored using the current mirror 210 on to transistor M3. The output circuit 212 has a first and second output transistors connected in series, M4, M5, where transistor M4's gate output 214 is connected to output signal Vpbias, and M5's gate and drain are connected together. Transistor [M4] 218 is configured to receive current 12. The output circuit is configured to generate a process dependent output signal that varies according to the process corners.

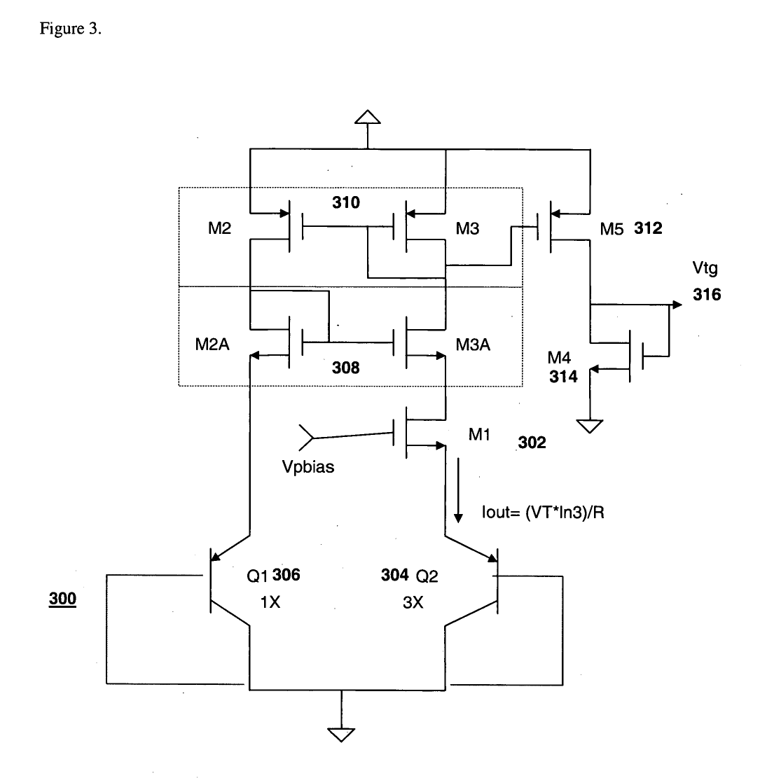

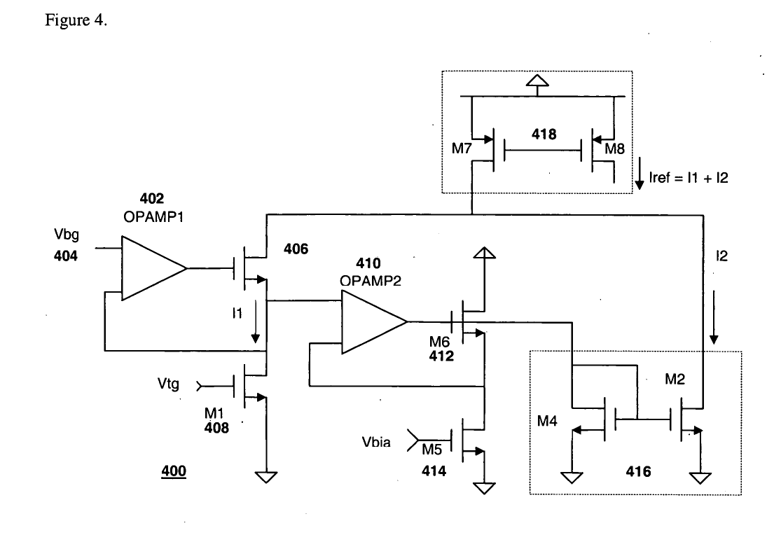

FIG. 3 illustrates a more detailed diagrammatic view of the temperature independent voltage generator. The temperature independent voltage generator reduces the temperature dependence of Vpbias while preserving the process dependency established in the process dependent voltage generator to generate a voltage labeled Vtg. Vpbias is used to bias a MOSFET, M1 in the linear region so that it acts as a resistor. This generates a current, IOUT that depends on the ratio of size of the 2 bipolar junction transistors (BJT), Q1 and Q2 and the resistance of M1 As illustrated, the bases and the collectors of Q1 and Q2 are connected together and connected and to ground. The optimum ratio was determined to be 3 empirically by simulations. This current thus varies proportionately with temperature because the ratio of the size of the BJTs varies proportionately with temperature and is approximately equal to VT*ln3/R where R is the resistance of M1 and VT is the thermal voltage. This current is then mirrored by MOSFETs M2 and M3 and impressed on to a diode connected MOSFET, M4, whose threshold voltage varies inversely proportional to temperature thus compensating for the temperature dependence of Iout to generate Vtg as shown in FIG. 3. This voltage is used to bias the mosfet M1, in the voltage to current converter (FIG. 4). In particular, in one embodiment as shown in FIG. 3, a temperature independent voltage generator 300 includes a transistor [M1] 302, biased in the linear region so as to act as a resistor is configured to receive an input voltage dependent bias voltage at its gate. 308 is a cascade current mirror circuit which mirrors the current from M1 to M5 through M3 and M3A. Additionally, Vpbias (FIG. 2) is connected to the gate of transistor [M1} 302. The collectors of transistor [Q1] and transistor [Q2] are connected to the gates of [Q1] and [Q2] respectively and are connected together to ground. When transistor [M1} receives an input signal it produces an output current lout to the emitter of transistor [Q2] 304. The current Iout is then mirrored by the cascade current mirror circuit 308. Transistor [M4] 314 receives the current from the current mirror circuit 308 through transistor [M5] 312. The output signal Vtg 316 is the gate voltage of transistor [M4] 314, configured to be independent of temperature.

FIG. 4 illustrates a more detailed diagrammatic view of the voltage to current converter. The voltage to current converter in effect adds the sum of 2 differently biased MOSFET current sources M1 and M2. The currents in these 2 MOSFETs vary in opposite directions with temperature and hence add up to provide a constant current with respect to temperature. The process dependent voltage compensates for the variation that we see in the reference current over process corners. OPAMP1 and OPAMP2 are configured to be unity gain voltage buffers. Vbias, connected to the gate of M5, is a voltage that is obtained by mirroring Vtg and is used to bias M5. In particular, in one embodiment as shown in FIG. 4, a voltage to current converter circuit includes an amplifier [OPAMP1] 402, configured to be a unity gain voltage buffer. The amplifier includes an input for receiving a voltage bias voltage, an output configured to output a current to the gate of a transistor 406 and another input for receiving a feedback signal I1 from the transistor 406. Transistor [M1] 408 is configured to receive a temperature independent voltage signal at its gate. The source of transistor 408 is connected to the drain of transistor 406 and the drain is connected to ground. The drain of transistor 406 is also connected to an input of amplifier [OPAMP 2] 410, configured to be a unity gain voltage buffer. Additionally, the amplifier includes an output configured to output a current to the gate of a transistor [M6] 412 and current mirror circuit 416, and another input for receiving a feedback signal I1 from the transistor [M6] 412. Transistor [M5] 414 is configured to receive a voltage bias voltage signal at its gate. The source of transistor 414 is connected to the drain of transistor 412 and the drain is connected to ground. The current mirror circuit 418 receives and sums the current from the current mirror circuit 416 and transistor 406. The current from the current mirror circuit 416 is generated based on the output of [OPAMP2] 410. The current from transistor 406 is generated based on the output of [OPAMP1] 402 and transistor M1 which is biased by the temperature independent voltage to be in the linear region and thus act as a resistor. The output signal from the current mirror circuit 418, Iref, is a substantially constant current with respect to process and temperature variables.

Generally, the invention has been described in the context of a system and related method for producing a reference bias current that varies within a limited threshold from its nominal value based on band gap voltage, and that generates the bias current substantially independent from process and temperature. In one embodiment, the invention provides a process dependant voltage generator, a temperature independent voltage generator, and a voltage to current converter receiving outputs from the bandgap voltage generator and a temperature independent voltage generator to generate a bias current that is substantially independent from process and temperature. Those skilled in the art will understand that there are other configurations of the circuits and methods described herein that vary insubstantially from the spirit and scope of the invention, which is defined by the appended claims and their equivalents.

1. An electronic device that delivers a reference bias current that varies within a limited threshold from its nominal value based on band gap voltage, comprising:
a process dependant voltage generator;
a temperature independent voltage generator, and
a voltage to current converter receiving outputs from the bandgap voltage generator and a temperature independent voltage generator to generate a bias current that is substantially independent from process and temperature.

2. An electronic device according to claim 1, wherein the process dependant voltage generator is configured to trim variance over process corners.

3. An electronic device according to claim 1, wherein the process dependant voltage generator is configured to trim variance over process corners and the temperature independent voltage generator compensate for the temperature dependencies of its output current.

4. An electronic device according to claim 1 configured to deliver a reference bias current that varies less than ±8% over process, temperature, and power supply corners.

5. An electronic device configured to generate a reference bias current that varies within a limited threshold from its nominal value based on band gap voltage, comprising:
a process dependent voltage generator having:
an amplifier for receiving a voltage bias voltage, an output configured to output a current to a transistor gate, and another input for receiving a feedback signal from the transistor;
a current mirror circuit connected to the transistor to produce a current in the transistor when a signal is received by the transistor from the amplifier;
a resistor connected at one end to the transistor and at another end to ground;
an output circuit having a first and second output transistors connected in series configured to generate a process dependent output signal that varies according to the process corners because their threshold voltage varies with process corners; and
a voltage to current converter receiving inputs from the bandgap voltage generator and a temperature independent voltage generator and to output a reference bias current based on the band gap voltage of the electronic device

6. An electronic device configured to generate a reference bias current that varies within a limited threshold from its nominal value based on band gap voltage, comprising:
a temperature independent voltage generator having a transistor for receiving a voltage dependent bias voltage at its gate that causes the transistor to be biased in the linear region so as to act as a resistor, wherein the source of transistor is connected to second transistor, whereas the output current of transistor is dependent on the ratio of the size of a pair of diode connected transistors, whereas the ratio of the size of the pair of diode connected transistors varies proportionately with temperature, wherein the output current of transistor also varies proportionately with temperature, wherein the collectors of the pair of diode connected transistors are both diode connected to ground, the generator also having cascode current mirror circuits configured to mirror the output current to the transistor.

7. An electronic device that delivers a reference bias current that varies within a limited threshold from its nominal value based on band gap voltage, comprising:
a voltage to current converter having:
a first amplifier for receiving a voltage bias voltage, configured to be a unity gain voltage buffer, an output configured to output a current to a transistor gate, and another input for receiving a feedback signal from the transistor;
a second amplifier for receiving a voltage from a transistor, configured to be a unity gain voltage buffer, an output configured to output a current to a transistor gate, and another input for receiving a feedback signal from the transistor;
a transistor configured to receive a temperature independent bias voltage at its gate, a drain configured to receive a current from a transistor, and a source that is connected to ground;
a second transistor configured to receive a voltage bias voltage that mirrors the temperature independent bias voltage and is used to bias the transistor at its gate, a drain configured to receive a signal from a transistor, and a source that is connected to ground;
a current mirror circuit connected to a transistor to produce a current in the transistor when a signal is received by the transistor from the first amplifier;
a second current mirror circuit connected to a transistor to produce a current in the transistor when a signal is received by the transistor from the second amplifier; the output of the current mirror circuit generates an output current that is a constant current with respect to temperature;
whereas the current in transistor is biased by a temperature independent bias voltage, wherein the output circuit adds the sum of the currents of transistors that vary in opposite directions with temperature, to provide a constant current with respect to temperature with the process dependent bias voltage compensating for variations resulting over process corners.
